(19) United States
(12) Patent Application Publication
(10) Pub. No.: US 2010/0122160 A1
(43) Pub. Date: May 13, 2010

(54) NON-CONTIGUOUS CONTENT DUPLICATION

(75) Inventors: Monsak Chirakansakcharoen, Raleigh, NC (US); Loc D. Dang, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/267,653

(22) Filed: Nov. 10, 2008

(51) Int. Cl. G06F 17/21

(52) U.S. Cl. 715/256

(57) ABSTRACT

Embodiments of the present invention address deficiencies of the art in respect to content cut-and-paste operations and provide a method, system and computer program product for cutting and pasting content from a source document to a target document. In an embodiment of the invention, a method for cutting and pasting content from a source document to a target document can include selecting multiple non-contiguous segments of content in a source document rendered in an activated application executing in a host computing platform, designating from within the activated application for each of the non-contiguous segments, an inactive target application in the host computing platform, and pasting the selected multiple non-contiguous segments of content into a target document rendered in the inactive target application while maintaining focus in the activated application and without activating the inactive target application.

### BACKGROUND OF THE INVENTION

1. Field of the Invention

The present invention relates to the field of content editing and more particularly to content cut-and-paste operations.

2. Description of the Related Art

The venerable cut-and-paste operation has formed the backbone of content editing since the widespread adoption of personal computing. Initially, the cut-and-paste operation acted strictly upon text within a textual document. With the advent of graphical computing systems, however, the cut-and-paste operation morphed into a grander function allowing for various content types including imagery, as well as inter-application content transfer. Popular embodiments of the cut-and-paste operation act upon spreadsheet, word processor and presentation content and allow for the embedding of content created in different applications within a single document.

Generally, the cut-and-paste operation requires the programmatic determination of a selected swath of contiguous content in a source document and the copying of the selected swath into a portion of memory referred to as the “clipboard”. Optionally, the copied content can be removed from the source document. The former circumstance is known as a “copy” while the latter circumstance is known as a “cut”. In either case, the swath of content in the clipboard can be copied into a selected portion of a target document, often referred to as a paste. Optionally, the swatch of content can be repeatedly copied into different portions of the same or different documents.

The conventional cut-and-paste operation requires the demarcation of a starting point and an ending point for a contiguous swatch of content in a source document. Oftentimes, however, end users require the copying of non-contiguous portions of content in a source document. Consequently, the end user must perform multiple different cut-and-paste operations in order to effectuate the copying of non-contiguous portions of content into a target document. For many different contiguous portions, the process can become tedious and confusing for the end user as the end user alternately activates the source document and the target document to perform the multiple different cut-and-paste operations.

### BRIEF SUMMARY OF THE INVENTION

Embodiments of the present invention address deficiencies of the art in respect to content cut-and-paste operations and provide a novel and non-obvious method, system and computer program product for cutting and pasting content from a source document to a target document. In an embodiment of the invention, a method for cutting and pasting content from a source document to a target document can include selecting multiple non-contiguous segments of content in a source document rendered in an activated application executing in a host computing platform, designating from within the activated application for each of the non-contiguous segments, an inactive target application in the host computing platform, and pasting the selected multiple non-contiguous segments of content into a target document rendered in the inactive target application while maintaining focus in the activated application and without activating the inactive target application.

In another embodiment of the invention, a content editing data processing system can be configured for cutting and pasting content from a source document to a target document. The system can include an operating system supported by a host computing platform, and non-contiguous cut-and-paste logic coupled to the operating system. The logic can include program code enabled to select multiple non-contiguous segments of content in a source document rendered in an activated application executing in the host computing platform, to designate from within the activated application for each of the non-contiguous segments, an inactive target application in the host computing platform, and to paste the selected multiple non-contiguous segments of content into a target document rendered in the inactive target application while maintaining focus in the activated application and without activating the inactive target application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of an exemplary user interface configured for cutting and pasting content from a source document to a target document;

FIG. 2 is a schematic illustration of a content editing data processing system configured for cutting and pasting content from a source document to a target document; and,

FIG. 3 is a flow chart illustrating a process for cutting and pasting content from a source document to a target document.

### DETAILED DESCRIPTION OF THE INVENTION

Embodiments of the present invention provide a method, system and computer program product for cutting and pasting content from a source document to a target document. In accordance with an embodiment of the present invention, a source document can be activated and multiple different non-contiguous portions of content in the source document can be selected. For each selected portion of content, while the source document remains activated, a target document can be identified and the selected portion of the content can be pasted into the target document at an insertion point within the target document without first de-activating the source document and activating the target document. Accordingly, multiple identifications of the target document for multiple different selected non-contiguous portions of the content can result in the contiguous pasting of the selected non-contiguous portions of the content into the target document.

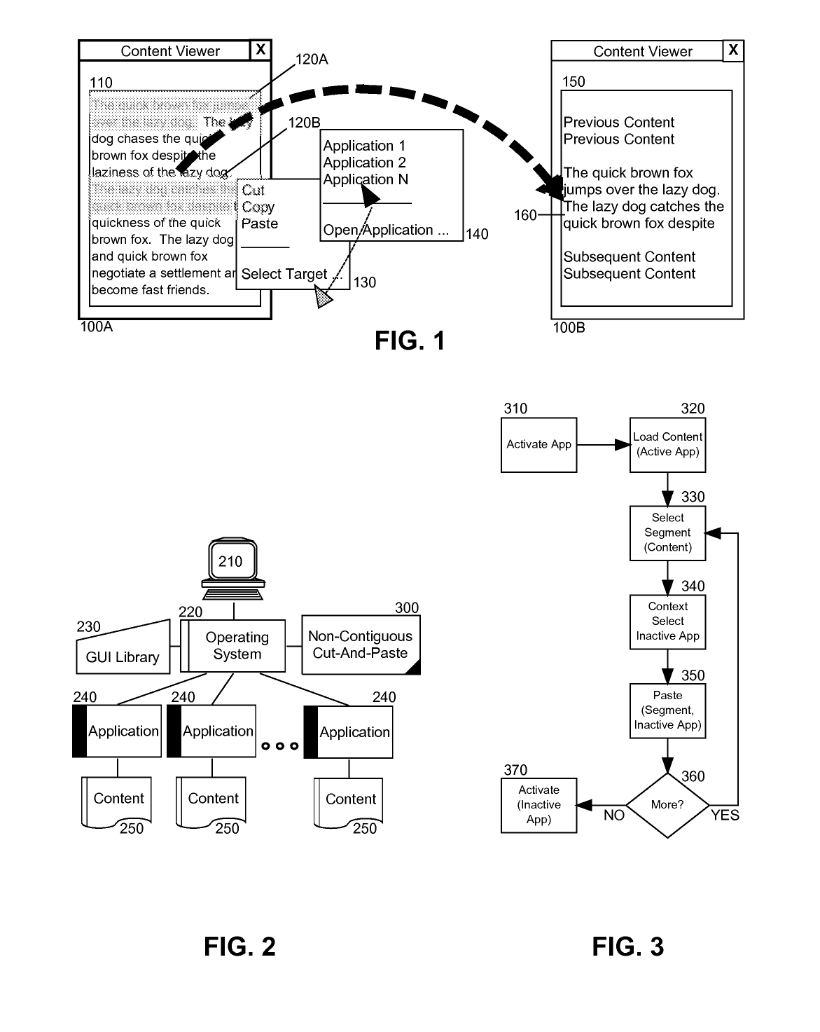

In further illustration, FIG. 1 is a pictorial illustration of an exemplary user interface configured for cutting and pasting content from a source document to a target document. As shown in FIG. 1, content 110 can be presented in a content viewer 100A, for example a Web browser, office productivity suite, e-mail client and the like. Non-contiguous portions 120A, 120B can be separately and sequentially selected for a cut-and-paste operation which can include either a cut or a copy of the non-contiguous portions 120A, 120B of the content 110. Subsequent to the selection of an individual one of the non-contiguous portions 120A, 120B, a context menu 130 can be activated through which a target application can be selected to receive a paste of the selected individual one of the non-contiguous portions 120A, 120B.

An additional context menu 140 of running applications can be presented in response to the selection of the target application menu item in the context menu 130. The additional context menu 140 further can permit the selection of a browser menu item to open a non-running application. Alternatively, the menu items of the additional context menu 140 can be presented inline with the context menu 130. In either circumstance, the selection of a running or non-running application through the context menus can trigger a cut-and-paste operation of the selected individual one of the non-contiguous portions 120A, 120B into an insertion point in content 150 rendered in content viewer 100B corresponding to the selected one of the running or non-running application 100B. Multiple selections of the non-contiguous portions 120A, 120B can result in the pasting of the non-contiguous portions 120A, 120B into the content 150 as a contiguous block 160 of the non-contiguous portions 120A, 120B.

The process described in connection with FIG. 1 can be implemented within a content editing data processing system. In yet further illustration, FIG. 2 is a schematic illustration of a content editing data processing system configured for cutting and pasting content from a source document to a target document. The system can include a host computing platform 210 supporting the operation of operating system 220. The operating system 220 can host the execution of multiple different applications 240 including content editors and viewers alike. The multiple different applications 240, in turn, can support the rendering of content 250. The operating system 220 also can include a library of graphical user interface (GUI) widgets and operations accessible through an application programming interface (API) such that the applications 240 can provide different GUI and GUI elements by reference to method calls to the API.

Importantly, non-contiguous cut-and-paste logic 300 can be coupled to the operating system 220. The non-contiguous cut-and-paste logic 300 can include program code enabled to direct the rendering of a context menu for a selected portion of content 250 in an activated one of the applications 240. The context menu can include an option to select an inactive or non-executing one of the applications 240 to receive a copy of the selected portion of the content in the activated one of the applications 240. The program code of the non-contiguous cut-and-paste logic 300 further can be enabled to paste the selected portion of the content into an insertion point in the inactive or non-executing one of the applications while maintaining the active state of the activated one of the applications 240 and without activating the inactive or non-executing one of the applications 240. In this way, multiple different non-contiguous portions of the content 250 in the activated one of the applications 240 can be cut-and-pasted into the inactive or non-executing one of the applications 240 without losing focus in the activated one of the applications 240.

In even yet further illustration of the operation of the non-contiguous cut-and-paste logic 300, FIG. 3 is a flow chart illustrating a process for cutting and pasting content from a source document to a target document. Beginning in block 310, an application can be activated and in block 320, content can be loaded for viewing (and possibly editing) in the activated application. In block 330, a portion of the content can e selected and in block 340, a context menu can be rendered through which an inactive application can be selected.

In block 350, the selected portion of the content can be pasted into an insertion point in the selected inactive application while maintaining focus in the activated application. In decision block 360, if additional portions of the content remain to be selected, the process can repeat through block 330. Otherwise, the selected inactive application can be activated (e.g. placed into focus) in block 370 thereby completing the process of a non-contiguous cut-and-paste of selected non-contiguous portions of content from a source document to a target document.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for cutting and pasting content from a source document to a target document comprising:
selecting multiple non-contiguous segments of content in a source document rendered in an activated application executing in a host computing platform;
designating from within the activated application for each of the non-contiguous segments, an inactive target application in the host computing platform; and,
pasting the selected multiple non-contiguous segments of content into a target document rendered in the inactive target application while maintaining focus in the activated application and without activating the inactive target application.

2. The method of claim 1, wherein designating from within the activated application for each of the segments, an inactive target application in the host computing platform, comprises:
designating from within the activated application for each of the segments, an inactive non-executing target application in the host computing platform; and,
executing the non-executing target application.

3. A content editing data processing system configured for cutting and pasting content from a source document to a target document, the system comprising:
an operating system supported by a host computing platform; and,
non-contiguous cut-and-paste logic coupled to the operating system, the logic comprising program code enabled to select multiple non-contiguous segments of content in a source document rendered in an activated application executing in the host computing platform, to designate from within the activated application for each of the non-contiguous segments, an inactive target application in the host computing platform, and to paste the selected multiple non-contiguous segments of content into a target document rendered in the inactive target application while maintaining focus in the activated application and without activating the inactive target application.

4. The system of claim 3, wherein the activated application is a Web browser.

5. The system of claim 3, wherein the activated application is an application in an office productivity suite.

6. The system of claim 3, further comprising a context menu listing a plurality of inactivate applications from which the inactive target application is designated.

7. The system of claim 6, wherein the listing further comprises a menu item for executing and designating a non-executing application stored in the host computing platform.

8. A computer program product comprising a computer usable medium embodying computer usable program code for cutting and pasting content from a source document to a target document, the computer program product comprising:
computer usable program code for selecting multiple non-contiguous segments of content in a source document rendered in an activated application executing in a host computing platform;
computer usable program code for designating from within the activated application for each of the non-contiguous segments, an inactive target application in the host computing platform; and,
computer usable program code for pasting the selected multiple non-contiguous segments of content into a target document rendered in the inactive target application while maintaining focus in the activated application and without activating the inactive target application.

9. The computer program product of claim 8, wherein the computer usable program code for designating from within the activated application for each of the segments, an inactive target application in the host computing platform, comprises:
computer usable program code for designating from within the activated application for each of the segments, an inactive non-executing target application in the host computing platform; and,
computer usable program code for executing the non-executing target application.
